(19) United States
(12) Patent Application Publication
(10) Pub. No.: US 2026/0126076 A1
(43) Pub. Date: May 7, 2026

(54) SUSPENSION MEMBER MOUNTING SPACER

(71) Applicant: TOYOTA JIDOSHA KABUSHIKI KAISHA, Toyota-shi, (JP)

(72) Inventor: Takahiro ITO, Toyota-shi (JP)

(73) Assignee: TOYOTA JIDOSHA KABUSHIKI KAISHA, Toyota-shi (JP)

(21) Appl. No.: 19/354,051

(22) Filed: Oct. 9, 2025

(30) Foreign Application Priority Data
Nov. 1, 2024 (JP) 2024-192846

(51) Int. Cl. F16B 43/00

(52) U.S. Cl. CPC F16B 43/00

(57) ABSTRACT

A suspension member mounting spacer includes: a body configured to be positioned between either an upper end face or a lower end face of a collar having a cylindrical shape and a vehicle body structural member, the collar being configured to pass in an up-down direction through a mounting hole of the suspension member provided in a vehicle and to be fixed to the suspension member; and a staking portion configured to protrude from the body into the collar and to be fixed to the collar by plastic deformation.

### CROSS REFERENCE TO RELATED APPLICATION

This application claims priority to Japanese Patent Application No. 2024-192846 filed on Nov. 1, 2024. The disclosure of the above-identified application, including the specification, drawings, and claims, is incorporated by reference herein in its entirety.

### BACKGROUND

### 1. Technical Field

The present disclosure relates to spacers for mounting a suspension member.

### 2. Description of Related Art

Japanese Unexamined Patent Application Publication No. 2010-95042 (JP 2010-95042 A) discloses a vehicle equipped with a suspension member.

When manufacturing a plurality of vehicles having different ride heights, the installation position of the suspension member to the vehicle body in the up-down direction is changed in accordance with the difference in ride height in order to enable the suspension member to be shared among the vehicles. For example, in a known method, a plurality of types of collars having different dimensions in the up-down direction is prepared, a collar is selected according to the vehicle ride height, and the selected collar is used to mount the suspension member to the vehicle body.

### SUMMARY

As the number of types of collars increases, it becomes difficult to efficiently use the storage space for components on the production line.

The present disclosure has been made in view of the above circumstances, and an object thereof is to provide a suspension member mounting spacer that enables a suspension member to be shared among a plurality of vehicles having different ride heights, without increasing the number of component types, when manufacturing the vehicles.

A suspension member mounting spacer of a first aspect includes: a body configured to be positioned between either an upper end face or a lower end face of a collar having a cylindrical shape and a vehicle body structural member,

the collar being configured to pass in an up-down direction through a mounting hole of the suspension member provided in a vehicle and to be fixed to the suspension member; and a staking portion configured to protrude from the body into the collar and to be fixed to the collar by plastic deformation.

The suspension member mounting spacer of the first aspect includes the body and the staking portion. The staking portion protrudes into the collar and is fixed to the collar by plastic deformation, whereby the collar and the spacer are integrated with each other. Moreover, the spacer can be integrated with the collar such that the body faces either the upper or lower end face of the collar. Accordingly, the collar can be fixed to the suspension member such that the body is positioned between either the upper or lower end face of the collar and the vehicle body structural member.

When the ride height of the vehicle is high, the collar is fixed to the suspension member such that the body is positioned between the upper end face of the collar and the vehicle body structural member. When the ride height of the vehicle is low, the collar is fixed to the suspension member such that the body is positioned between the lower end face of the collar and the vehicle body structural member. The suspension member mounting spacer of the first aspect enables the suspension member to be shared among a plurality of vehicles having different ride heights, without increasing the number of component types, when manufacturing the vehicles.

According to a suspension member mounting spacer of a second aspect, in the first aspect, the vehicle body structural member includes an upper support portion and a lower support portion located below the upper support portion. A shaft member is configured to pass through the collar, and is configured to pass through the upper support portion and the lower support portion and to be fixed to the upper support portion and the lower support portion. The body is configured to be provided between the upper end face of the collar and the upper support portion, or between the lower end face of the collar and the lower support portion.

The suspension member mounting spacer of the second aspect enables the suspension member that is disposed between the upper support portion and the lower support portion to be shared among a plurality of vehicles having different ride heights, without increasing the number of component types, when manufacturing the vehicles.

According to a suspension member mounting spacer of a third aspect, in the first or second aspect, the lower support portion is a flat plate-shaped brace that extends perpendicular to the up-down direction of the vehicle.

In the suspension member mounting spacer of the third aspect, the lower support portion is a flat plate-shaped brace that extends perpendicular to the up-down direction of the vehicle. Therefore, the brace of the third aspect has higher rigidity than a bent plate-shaped brace. Accordingly, with the suspension member mounting spacer of the third aspect, the suspension member can be supported stably by the vehicle body structural member.

As described above, the suspension member mounting spacer according to the present disclosure enables the suspension member to be shared among a plurality of vehicles having different ride heights, without increasing the number of component types, when manufacturing such vehicles.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view of a left rear portion of a first vehicle provided with a suspension member mounting spacer according to an embodiment, as viewed from the front.

FIG. 2 is an exploded perspective view of the suspension member mounting spacer and part of a collar; and

FIG. 3 is a sectional view of a left rear portion of a second vehicle provided with the suspension member mounting spacer, as viewed from the front.

### DETAILED DESCRIPTION OF EMBODIMENTS

A suspension member mounting spacer (hereinafter simply referred to as “spacer”) according to an embodiment will be described below with reference to the accompanying drawings. In the drawings, an arrow UP indicates the upward direction in the vehicle up-down direction, and an arrow LH indicates the leftward direction in the vehicle left-right direction.

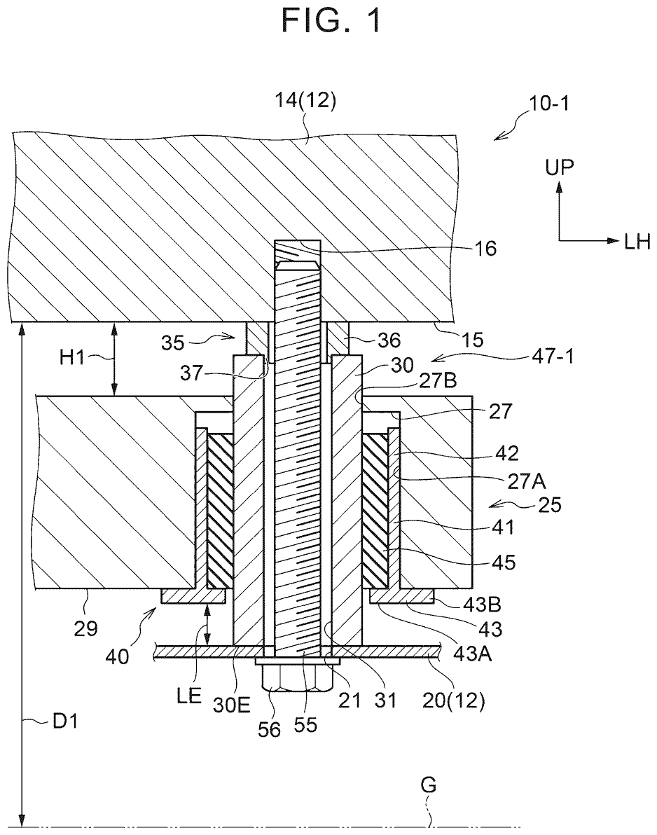

As shown in FIG. 1, vehicles (a first vehicle 10-1 and a second vehicle 10-2) to which a spacer 35 of the present embodiment is applied include a vehicle body structural member 12 that constitutes a rear portion of the vehicle body. The vehicle body structural member 12 includes a rear side member section (upper support portion) 14 and a brace 20 located below the rear side member section 14. The rear side member section 14 is a part of a vehicle body frame member produced by aluminum die casting. An internally threaded hole 16 is formed in a bottom surface 15 of the rear side member section 14.

The vehicle includes the brace 20 located below the rear side member section 14. The brace 20 is made of metal. The brace 20 is a flat plate-shaped member extending perpendicular to the up-down direction. The term “perpendicular” herein includes both exactly perpendicular and substantially perpendicular directions. The brace 20 is fixed to a collar 30 (spacer 35), which will be described later, and supports an under cover (not shown) that serves as a member that streamlines airflow beneath the vehicle floor while the vehicle is traveling. A through hole 21 is formed in the brace 20.

A suspension member 25 is a metal component produced by aluminum die casting. That is, the suspension member 25 is a one-piece molded component. An e-axle (not shown) is supported by the suspension member 25 of the present embodiment. The e-axle is provided with an axle extending in the left-right direction. The axle is rotated by the driving force of an electric motor provided in the e-axle, and the right and left rear wheels are connected to the right and left ends of the axle, respectively.

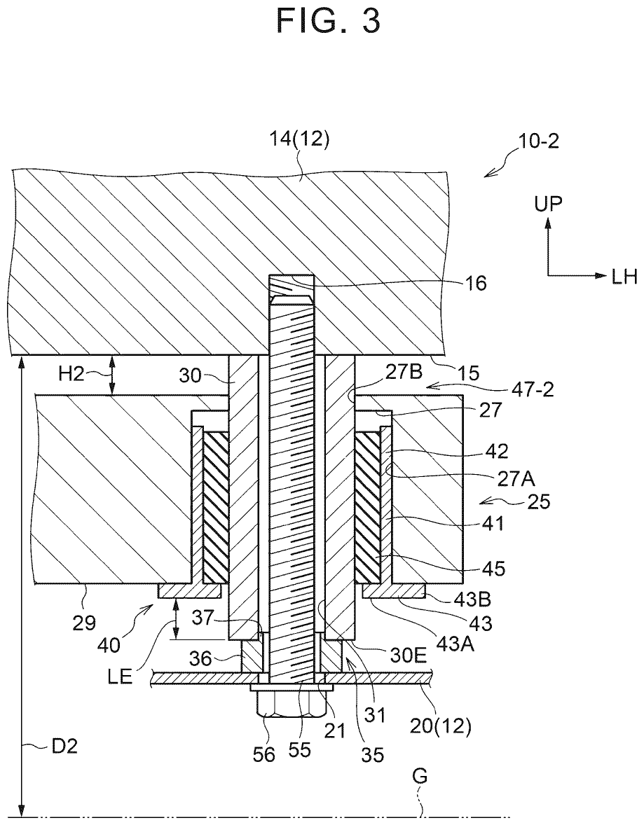

Mounting holes 27 extending through the suspension member 25 in the up-down direction are formed at two positions on the right and left sides of the suspension member 25 (only the left mounting hole 27 is shown in FIGS. 1 and 3). Each mounting hole 27 includes a large-diameter portion 27A that is a portion of the mounting hole excluding the upper end thereof, and a small-diameter portion 27B that constitutes the upper end.

The collar 30 is a tubular member made of a hard material and is insertable into each mounting hole 27 of the suspension member 25. The outer diameter of the collar 30 is smaller than the diameter of the small-diameter portion 27B. The axis of the collar 30 is substantially aligned with the up-down direction. The overall length (dimension in the up-down direction) of the collar 30 is greater than the dimension of the suspension member 25 in the up-down direction.

A rubber bush 40 is fixedly provided on the outer peripheral surface of the collar 30. The rubber bush 40 includes a base plate 41 and a substantially cylindrical rubber member 45 fixed to the inner peripheral surface of the base plate 41. The base plate 41 includes a cylindrical portion 42 having a substantially cylindrical shape and centered on an axis extending in the up-down direction, and an annular bottom plate 43 connected to a lower end of the cylindrical portion 42. The bottom plate 43 includes an inner peripheral portion 43A located radially inward of the cylindrical portion 42, and an outer peripheral portion 43B located radially outward of the cylindrical portion 42. As shown in FIG. 1, the rubber member 45 is provided on the inner periphery of the cylindrical portion 42, and a lower end face of the rubber member 45 is in contact with the inner peripheral portion 43A of the bottom plate 43. The base plate 41 and the rubber member 45 are fixed to each other.

As shown in FIG. 1, the collar 30 passes upward through the internal space of the rubber member 45, and the rubber member 45 is fixed to a central portion of the collar 30 in the up-down direction. That is, the collar 30 and the rubber bush 40 are integrated with each other. As shown in FIGS. 1 and 3, the distance between the bottom plate 43 and one end face 30E of the collar 30 is denoted as LE.

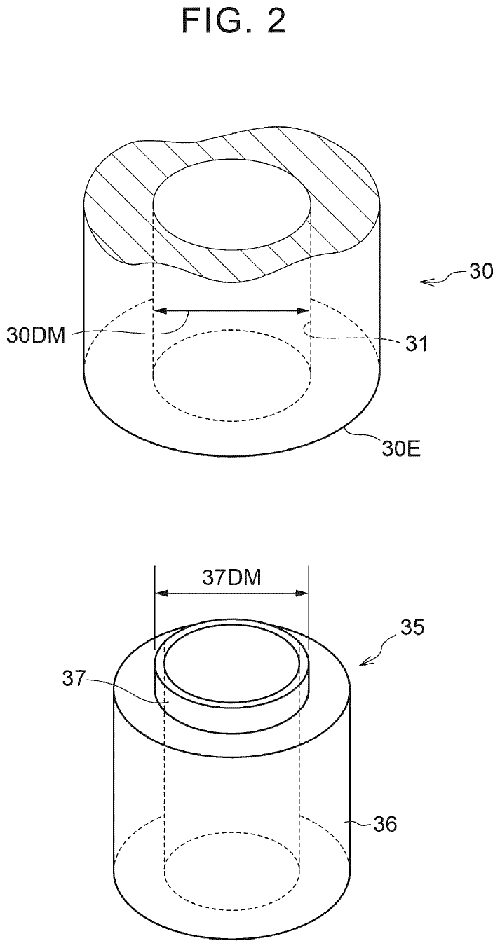

The spacer 35 is connectable to either the upper or lower end face of the collar 30. The spacer 35 includes a body 36 and a staking portion 37. The body 36 is a tubular body having a smaller diameter than the collar 30 and forming a body of revolution coaxial with the collar 30. The staking portion 37 is a tubular body provided on either the upper or lower surface of the body 36. As shown in FIG. 2, before the spacer 35 is connected to the collar 30, the outer diameter 37DM of the staking portion 37 is smaller than the inner diameter 30DM of an internal through hole 31 of the collar 30. Therefore, the staking portion 37 can be smoothly inserted into the internal through hole 31 of the collar 30. For example, as shown in FIGS. 2 and 3, when connecting the spacer 35 to the end face 30E of the collar 30, the spacer 35 is brought close to the end face 30E of the collar 30, and the staking portion 37 is inserted into the internal through hole 31 from one open end of the internal through hole 31. The body 36 is then brought into contact with the end face 30E of the collar 30. In this state, a tool (not shown) is inserted into the internal space of the body 36, and the staking portion 37 is plastically deformed outward in the radial direction by the tool. That is, the staking portion 37 is staked against the inner peripheral surface of the internal through hole 31 using the tool. The spacer 35 is thus fixed to the end of the collar 30.

Accordingly, in the present embodiment, it is possible to manufacture two types of integrated components that include the collar 30, the spacer 35, and the rubber bush 40. That is, the following two types of integrated components can be manufactured: a first integrated component 47-1 in which the spacer 35 is fixed to the end face of the collar 30 opposite to the end face 30E as shown in FIG. 1; and a second integrated component 47-2 in which the spacer 35 is fixed to the end face 30E of the collar 30 as shown in FIG. 3.

In the present embodiment, the spacer 35 is applied to two types of vehicles having different ride heights. Specifically, the spacer 35 is applied to the first vehicle 10-1 that is a vehicle having a high ride height such as a sport utility vehicle (SUV), and the second vehicle 10-2 that is a vehicle having a low ride height such as a sedan.

FIG. 1 illustrates the left rear portion of the first vehicle 10-1. In this case, the first integrated component 47-1 is inserted into the mounting hole 27 of the suspension member 25 from below such that the spacer 35 fixed to the upper end of the collar 30 and the upper end of the collar 30 extend upward through and beyond the mounting hole 27 of the suspension member 25. At this time, the outer peripheral portion 43B of the base plate 41 is brought into contact with a lower surface 29 of the suspension member 25. Moreover, the cylindrical portion 42 of the base plate 41 is press-fitted onto the inner peripheral surface of the large-diameter portion 27A of the mounting hole 27, whereby the first integrated component 47-1 is integrated with the suspension member 25. In addition, the upper surface of the brace 20 is brought into contact with the end face 30E of the collar 30 such that the internal through hole 31 of the collar 30 is aligned concentrically with the through hole 21 of the brace 20. A bolt (shaft member) 55 is then inserted into the through hole 21 from below the brace 20. The upper end face of the body 36 of the spacer 35 is brought into contact with the bottom surface 15 of the rear side member section 14 such that the body 36 is coaxial with the internally threaded hole 16. The bolt 55 is then threaded into the internally threaded hole 16 such that a head 56 of the bolt 55 is pressed against the lower surface of the brace 20. The collar 30, the spacer 35, the rubber bush 40, and the bolt 55 are thus fixed to the rear side member section 14, the suspension member 25, and the brace 20. In this way, the first integrated component 47-1 and the suspension member 25 are mounted to the first vehicle 10-1 (the rear side member section 14) by using the brace 20 and the bolt 55. In this case, the distance between the bottom surface 15 of the rear side member section 14 and the upper surface of the suspension member 25 in the up-down direction is denoted as H1. The distance between the ground surface G on which the wheels (rear wheels) are placed and the bottom surface 15 of the rear side member section 14 in the up-down direction is a first distance D1.

FIG. 3 illustrates the left rear portion of the second vehicle 10-2. In this case, the second integrated component 47-2 is inserted into the mounting hole 27 of the suspension member 25 from below such that the upper end of the collar 30 extends upward through and beyond the mounting hole 27 of the suspension member 25. The spacer 35 is fixed to the end face 30E of the collar 30. At this time, the outer peripheral portion 43B of the base plate 41 is brought into contact with the lower surface 29 of the suspension member 25. Moreover, the cylindrical portion 42 of the base plate 41 is press-fitted onto the inner peripheral surface of the large-diameter portion 27A of the mounting hole 27, whereby the second integrated component 47-2 is integrated with the suspension member 25. In addition, the upper surface of the brace 20 is brought into contact with the lower surface of the body 36 of the spacer 35 such that the internal space of the body 36 is aligned concentrically with the through hole 21. The bolt 55 is then inserted into the through hole 21 from below the brace 20. The upper end face of the collar 30 is brought into contact with the bottom surface 15 of the rear side member section 14 such that the internal through hole 31 is coaxial with the internally threaded hole 16. The bolt 55 is then threaded into the internally threaded hole 16 such that the head 56 is pressed against the lower surface of the brace 20. The collar 30, the spacer 35, the rubber bush 40, and the bolt 55 are thus fixed to the rear side member section 14, the suspension member 25, and the brace 20. In this way, the second integrated component 47-2 and the suspension member 25 are mounted to the second vehicle 10-2 (the rear side member section 14) by using the brace 20 and the bolt 55. In this case, the distance between the bottom surface 15 of the rear side member section 14 and the upper surface of the suspension member 25 in the up-down direction is denoted as H2. The distance H2 is smaller than the distance H1. The distance between the ground surface G on which the wheels (rear wheels) are placed and the bottom surface 15 of the rear side member section 14 in the up-down direction is a second distance D2. The second distance D2 is smaller than the first distance D1.

### Functions and Effects

Next, the functions and effects of the present embodiment will be described.

As described above, the spacer 35 of the present embodiment includes the body 36 and the staking portion 37. The staking portion 37 protrudes into the internal through hole 31 of the collar 30 and is fixed to the collar 30 by plastic deformation, whereby the collar 30 and the spacer 35 are integrated with each other. Moreover, the spacer 35 can be integrated with the collar 30 such that the body 36 faces either the upper or lower end face of the collar 30. Accordingly, the collar 30 can be fixed to the suspension member 25 such that the body 36 is positioned between either the upper or lower end face of the collar 30 and the vehicle body structural member 12 (the rear side member section 14 or the brace 20).

In the case of the first vehicle 10-1 having a high ride height, the collar 30 is fixed to the suspension member 25 such that the body 36 is positioned between the upper end face of the collar 30 and the rear side member section 14. In the case of the second vehicle 10-2 having a low ride height, the collar 30 is fixed to the suspension member 25 such that the body 36 is positioned between the lower end face of the collar 30 and the brace 20. The spacer 35 enables the suspension member 25 to be shared among a plurality of types of vehicles having different ride heights, without increasing the number of component types, when manufacturing such vehicles.

Furthermore, the brace 20 that is a part of the vehicle body structural member 12 is a flat plate-shaped member that extends perpendicular to the up-down direction of the vehicle. Therefore, the brace 20 has higher rigidity than a bent plate-shaped brace. Accordingly, the suspension member 25 can be supported more stably by the rear side member section 14 and the brace 20 of the present embodiment than in a case where a bent plate-shaped brace is used.

Although the spacer and the spacer assembly method in the vehicle according to the embodiment have been described above, various design modifications may be made without departing from the spirit and scope of the present disclosure.

For example, the outer diameter of the body 36 may be equal to the outer diameter of the collar 30, or may be greater than the outer diameter of the collar 30.

The staking portion 37 may not have a cylindrical shape. For example, the staking portion 37 may be constituted by a plurality of portions arranged at intervals in the circumferential direction.

The suspension member 25 may be mounted to a vehicle body structural member other than the rear side member section 14 and the brace 20 by using the collar 30 and the spacer 35. Examples of such a vehicle body structural member include a member fixed to the rear side member section 14, a front side member section that is a part of a vehicle body frame member produced by aluminum die casting, and a member fixed to the front side member section.

The vehicle body frame member may not be a component produced by aluminum die casting. That is, each of the frame members including rear side members, front side members, rockers, and cross members may be individually manufactured and then integrated with each other after manufacturing.

What is claimed is:

1. A suspension member mounting spacer comprising:
a body configured to be positioned between either an upper end face or a lower end face of a collar having a cylindrical shape and a vehicle body structural member, the collar being configured to pass in an up-down direction through a mounting hole of a suspension member provided in a vehicle and to be fixed to the suspension member; and
a staking portion configured to protrude from the body into the collar and to be fixed to the collar by plastic deformation.

2. The suspension member mounting spacer according to claim 1, wherein:
the vehicle body structural member includes an upper support portion and a lower support portion located below the upper support portion;
a shaft member is configured to pass through the collar, and is configured to pass through the upper support portion and the lower support portion and to be fixed to the upper support portion and the lower support portion; and
the body is configured to be provided between the upper end face of the collar and the upper support portion, or between the lower end face of the collar and the lower support portion.

3. The suspension member mounting spacer according to claim 2, wherein the lower support portion is a flat plate-shaped brace that extends perpendicular to the up-down direction of the vehicle.
